(19) United States
(12) Patent Application Publication
(10) Pub. No.: US 2010/0021092 A1
(43) Pub. Date: Jan. 28, 2010

(54) Structure of air vent passage for sealed bag, sealed bag and method of manufacturing sealed bag

(76) Inventors: Ryouichi Ootsubo, Kashihara-shi (JP); Kazuya Tanaka, Kashihara-shi (JP)

Correspondence Address: BIRCH STEWART KOLASCH & BIRCH, PO BOX 747, FALLS CHURCH, VA, 22040-0747, US

(21) Appl. No.: 11/794,341

(22) PCT Filed: Dec. 28, 2004
(86) PCT No.: PCT/JP04/19627

§ 371 Date: Feb. 27, 2008

(51) Int. Cl. B65D 33/01; B31B 41/00; B65D 30/24; B31B 1/84

(52) U.S. Cl. 383/100; 493/210

(57) ABSTRACT

A structure of an air vent passage of a sealed bag used for the sealed bag having a sealed part sealable in an airtight state, the sealed bag, and a method of manufacturing the sealed bag. In the structure, at least two sheets of valve element sheets (31) as a set are longitudinally stacked on each other and disposed between bag sheets (11) and (12). There are two or more fitted portions (C1) and (C2) on each set of valve units (3u) where one of the valve element sheets (31) is fitted to the bag sheets (11) and (12) or the other of the valve element sheets (31) facing the fitted surface (31a) of the valve element sheets (31). The structure is characterized in that the combination of the bag sheets (11) and (12) with the valve element sheets (31) or the combination of the valve element sheets (31) with each other forming the fitted portions (C1) and (C2) are different from each other for each of the fitted portions (C1) and (C2).

### BACKGROUND OF THE INVENTION

1. Field of the Invention

The present invention relates to a sealed bag in which an inner part thereof can be sealed in an airtight state.

2. Description of the Related Art

Conventionally, there has been used a sealed bag in which a sealed portion can be sealed in an airtight state, the sealed portion and the outside of the bag are coupled to each other to freely carry out ventilation in order to discharge various gases such as air present in the sealed portion to the outside of the bag and to maintain the state or to fill the sealed portion with the various gases and to maintain the state, and an air current passage space to be a space through which a gas passes is opened and closed when the gas is to be discharged or filled, so that the passage of the air current in one direction can be permitted and the air current in the other direction can be blocked.

As a kind of the sealed bags, there have widely been used bag elements in which a predetermined portion of a sheet having flexibility and made of a resin is bonded through heat sealing or the like to form sealed portions 102 and 202 having a space enclosed with the sheet, that, is, compression bags 101 and 201 capable of discharging a gas present in the sealed portions 102 and 202 to the outside of the bag and maintaining the state.

The compression bags 101 and 201 are provided with opening portions 103 and 203 for putting an article M in/out of the sealed portions 102 and 202. Moreover, the opening portions 103 and 203 are provided with closing units 104 and 204 such as fasteners for bringing the opening portions 103 and 203 into a sealed state.

There are various compression bags as embodiments of the compression bags. They are roughly divided into the following two types of compression bags 101 and 201.

First of all, Japanese Laid-Open Patent Publication No. 9-309544 describes a compression bag. For simple illustration, FIG. 9 shows a compression bag 101 having a check valve 105. In this example, the check valve 105 used in the compression bag 101 includes an outer tubular portion 107 in which outer tubular sheets 107a and 107b having flexibility and made of a resin are formed into a flat cylinder in such a manner that the space in the sealed portion 102 and the outside of the compression bag 101 are continuous, and a valve element sheet 106 provided in the outer tubular portion 107 and constituted by a sheet having flexibility and made of a resin as shown in FIG. 9B.

The valve element sheet 106 permits the passage of an air current F1 flowing from the sealed portion 102 toward the outside of the compression bag 101 and blocks an air current F2 in a reverse direction. By the check valve 105, a deaerated state is maintained even after the deaeration of the sealed portion 102.

The compression bag 101 can maintain the deaerated state after accommodating an article M in the sealed portion 102 and then discharging the air in the sealed portion 102 to the outside of the bag through the check valve 105 in a state in which the closing unit 104 is closed.

This is particularly effective for the article M which contains air to increase a volume by itself, such as clothes and blankets, because the air contained in the article M itself can be discharged to the outside of the compression bag 101. For this reason, the compression bag 101 with the article M accommodated therein can be stored in a compactified manner. Therefore, the compression bag 101 is suitable for a bag for storing clothes or the like, and a sorting bag for travels.

However, the check valve 105 is manufactured separately from the bag sheets 102a and 102b constituting the sealed portion 102 and is subsequently incorporated when the sealed portion 102 is formed. Therefore, a step of manufacturing the check valve 105 and a step of incorporating the check valve 105 into the sealed portion 102 are required respectively, so that the process for manufacturing the compression bag 101 is complicated. For this reason, a special manufacturing apparatus has to be used, causing an increase in manufacturing cost.

Moreover, when the check valve 105 is incorporated in the compression bag 101 as described above, a heat sealed portion 108 is formed as shown in FIG. 9B and the bag sheets 102a and 102b constituting the sealed portion 102 and the outer tubular portion 107 of the check valve 105 are bonded to each other. The heat sealed portion 108 is formed so as to cross the check valve 105, by carrying out pressing by means of a heated metal mold from both sides of the bag sheets 102a and 102b in a state where the check valve 105 is interposed between the bag sheets 102a and 102b.

In this case, therefore, a coating material 106b for preventing a surface 106a on an opposed side to an inner surface of the outer tubular portion 107 from being molten by the heat in the heat sealing is applied to the surface 106a in the valve element sheet 106 in order to prevent the outer tubular portion 107 of the check valve 105 and the valve element sheet 106 from being heat sealed together, for example. Although the coating material 106b is thus applied, the inner surface of the outer tubular sheet 107a in the outer tubular portion 107 is slightly molten by the influence of the heat in the heat sealing and the pressure of the metal mold for carrying out the heat sealing. Consequently, the outer tubular portion 107 and the valve element sheet 106 are actually brought into a lightly heat sealed state (a lightly heat sealed portion 109). The lightly heat sealed portion 109 is removed by small external force; however, in the case where the compression bag 101 is first used, an internal pressure of the sealed portion 102 is raised while the lightly heat sealed portion 109 is removed so that the outer tubular portion 107 and the valve element sheet 106 are separated from each other and the check valve 105 is thus opened. Therefore, there is a drawback that a high resistance is generated in deaeration, causing a very long time to be taken. Depending on the circumstances, there is a possibility that the bag sheets 102a and 102b of the sealed portion 102 might burst. These are particularly remarkable problems in the case where the sealed portion 102 is pressed by hands to carry out the deaeration.

On the other hand, there is a compression bag 201 having another constitution which relates to the invention disclosed in U.S. Pat. No. 6,116,781 as shown in FIG. 10. Referring to the compression bag 201, there is formed a check valve 205 in which an intermediate sheet 206 is interposed between two bag sheets 202a and 202b which are opposed to each other and a portion between the bag sheets 202a and 202b and the intermediate sheet 206 is set to be an air passage for deaeration. The check valve 205 fulfills a checking function with the bag sheets 202a and 202b tightly contacting to the intermediate sheet 206.

In the compression bag 201, the check valve 205 is integrally formed from the beginning. Therefore, there is an advantage that the compression bag 201 can be manufactured through one step, unlike the compression bag 101. Moreover, the problem of forming the lightly heat sealed portion 109 at the time of incorporating the check valve 105 as a separate unit does not occur in the compression bag 201.

However, the compression bag 201 is obtained by simply interposing the intermediate sheet 206 between the bag sheets 202a and 202b. In the case where the bag sheets 202a and 202b and the intermediate sheet 206 are wrinkled, leakage is generated. For this reason, the checking function is imperfect and the deaeration state of the sealed portion 202 cannot be maintained reliably.

It can be proposed that a plurality of valve element sheets 106 are provided inside the outer tubular portion 107 in a serial direction to the direction of an air current as shown in FIG. 9C, in order to enhance the checking function in the case of using the check valve 105 shown in FIG. 9. With the structure, double blocking is carried out by the valve element sheet 106. Consequently, the checking effect can be obtained more reliably.

In the structure in which a plurality of the valve element sheets 106 are required for one check valve 105, however, an increase in manufacturing cost is unavoidable.

In consideration of the foregoing various problems, it is an object of the present invention to provide a structure of an air vent passage for a sealed bag, the sealed bag and a method of manufacturing the sealed bag with which the manufacturing can be carried out through one step so that the manufacturing cost can be reduced, an airtight state of the sealed portion can be maintained reliably, and a resistance in ventilation can also be reduced for easy handling.

### SUMMARY OF THE INVENTION

In order to solve the problems, a first aspect of the present invention is directed to a structure of an air vent passage for a sealed bag. The structure is used in a sealed bag that is capable of sealing a sealed portion in an airtight state and coupled to an outside of the bag to freely carry out ventilation in order to discharge a gas present in the sealed portion to the outside of the bag and to maintain the state or to fill the sealed portion with a gas and to maintain the state. The structure permits passage of an air current in one direction and blocks an air current in the other direction by opening and closing an air current passage space that is a space through which the gas passes in order to discharge or fill the gas. The structure is comprised of flexible bag sheets made of a resin and a valve element sheet. The bag sheets are disposed opposite to each other in a longitudinal direction, and at least two valve element sheets make a set and are disposed in superposition in the longitudinal direction between the bag sheets. Part of the valve element sheet is bonded to either the bag sheets or the other valve element sheet in a bonding portion, and a movable portion other than the bonding portion is set to be movable, and a set of a valve unit is constituted by the set of the valve element sheets. An air vent passage is defined by a pair of air vent passage side seals obtained by bonding the bag sheets and the valve element sheets integrally with each other. The air vent passage has one end conducted to the sealed portion and the other end conducted to the outside of the bag. The air vent passage side seal is formed along an air current in a forward direction in which the gas can be permitted to pass through the air vent passage. The bonding portion of the valve element sheet is disposed on an upstream side of the air current in the forward direction, and the movable portion is disposed on a downstream side thereof. A surface on an opposite side to inner surfaces of the bag sheets on a side where the valve element sheet to which the movable portion belongs is bonded in the movable portion is a separated surface. A surface provided on an opposite side of the separated surface is an adhering surface. When the air current passes in the forward direction, the valve element sheet and the bag sheets or the valve element sheet on the other side which are opposed to the adhering surface of the valve element sheet are separated from each other, then the air current passage space is opened with respect to said air current. When an air current in a reverse direction flows in to the forward direction, the valve element sheet and the bag sheets or the valve element sheet on the other side which are opposed to the adhering surface of the valve element sheet adhere to each other in adhering portions and the air current passage space is closed with respect to said air current. At least two adhering portions are present for each one set of the valve unit, wherein a combination constituting the respective adhering portions between the bag sheets and the valve element sheet or the valve element sheets themselves is different for each of the adhering portions.

Moreover, a second aspect of the present invention is directed to the structure of an air vent passage for a sealed bag according to the first aspect of the present invention, wherein a longitudinal dimension that is a dimension in a direction of an air current in one of the valve element sheets to be used in the set of the valve unit is different from a longitudinal dimension of at least one of the other valve element sheets.

Furthermore, a third aspect of the present invention is directed to the structure of an air vent passage for a sealed bag according to the first or second aspect of the present invention, wherein at least a set of the valve element sheet disposed relatively on a front side and the valve element sheet disposed relatively on a rear side is constituted by one sheet, and the one sheet is folded in such a manner that one side is wide and the other side is narrow by setting, as a boundary, a folding line which is disposed orthogonally to a direction of an air current.

In addition, a fourth aspect of the present invention is directed to a sealed bag which have a sealed portion and an air vent passage provided adjacent to the sealed portion for coupling the sealed portion to the outside of the bag to freely carry out ventilation. The bag is capable of sealing the sealed portion in an airtight state and of discharging a gas present in the sealed portion to an outside of the bag before maintaining the state or filling the sealed portion with a gas before maintaining the state. The bag permits passage of an air current in one direction and blocks the air current in the other direction by opening and closing an air current passage space that is a space through which a gas passes in the air vent passage in order to discharge or fill the gas. The sealed bag is comprised of flexible bag sheets made of a resin and a valve element sheet. The bag sheets are disposed opposite to each other, and at least two valve element sheets make a set between the bag sheets, further at least part of the valve element sheet is disposed in superposition in a longitudinal direction in the air vent passage. Part of the valve element sheet is bonded to the bag sheets or the other valve element sheet in a bonding portion, and a movable portion other than the bonding portion is set to be movable, and a set of a valve unit set is constituted by the set of the valve element sheets. The air vent passage is defined by a pair of air vent passage side seals obtained by bonding the bag sheets and the valve element sheets integrally with each other and formed along an air current in a forward direction in which a gas can pass through the air vent passage. The air vent passage has one end conducted to the sealed portion and the other end conducted to the outside of the bag. The bonding portion of the valve element sheet is disposed on an upstream side in the air current in the forward direction, and the movable portion is disposed on a downstream side thereof. A surface on an opposite side to the bag sheets on a side where the valve element sheet to which the movable portion belongs is bonded or the other valve element sheet on a side wherein the valve element sheet to which the movable portion belongs is bonded is a separated surface in the movable portion. A surface provided on an opposite side of the separated surface is an adhering surface. When the air current passes in the forward direction, the valve element sheet and the bag sheets or the valve element sheet on the other side which are opposed to the adhering surface of the valve element sheet are separated from each other, then the air current passage space is opened with respect to said air current. When an air current in a reverse direction flows in to the forward direction, the valve element sheet and the bag sheets or the valve element sheet on the other side which are opposed to the adhering surface of the valve element sheet adhere to each other in adhering portions, then the air current passage space is closed with respect to said air current. At least two adhering portions are present for each one set of the valve unit, wherein a combination constituting the respective adhering portions between the bag sheets and the valve element sheet or the valve element sheets themselves is different for each of the adhering portions.

Moreover, a fifth aspect of the present invention is directed to the sealed bag according to the fourth aspect of the present invention, wherein the sealed portion is a portion on an upper side of a sealed portion partitioning seal, and the portion is defined by the sealed portion partitioning seal and a bag side seal for defining both of left and right ends of the sealed bag. The sealed portion partitioning seal is obtained by integrally bonding at least the bag sheets and extended in a transverse direction. The air vent passage is further defined by the air vent passage side seal in a lower portion defined by the sealed portion partitioning seal, and the sealed portion partitioning seal is not provided in a conducting portion of the sealed portion and the air vent passage.

Furthermore, a sixth aspect of the present invention is directed to a method of manufacturing a sealed bag having a sealed portion and an air vent provided adjacent to the sealed portion for coupling the sealed portion to the outside of the bag to freely carry out ventilation. The bag is capable of sealing the sealed portion in an airtight state and of discharging a gas present in the sealed portion to an outside of the bag before maintaining the state or filling the sealed bag with a gas before maintaining the state. The bag permits passage of an air current in one direction and blocks the air current in the other direction by opening and closing an air current passage space that is a space through which a gas passes in the air vent passage in order to discharge or fill the gas. The method is comprised of the steps of the following. A first step is to use flexible bag sheets made of a resin and flexible at least two valve element sheets made of a resin. The bag sheets are supplied continuously in a longitudinal direction, and the valve element sheets are supplied continuously in the longitudinal direction and have a longitudinal dimension that is a dimension in a short direction and is smaller than longitudinal dimensions of the bag sheets. A second step is to superpose the valve element sheet on a portion in which an air vent passage is to be formed in each of the front bag sheet and the rear bag sheet. A third step is to bond the bag sheets and the valve element sheet together by forming a valve element adhesive seal in a part of an upstream side in an air current in a forward direction in which a gas is permitted to pass through the air vent passage in the valve element sheet. A fourth step is to superpose the front bag sheet and the rear bag sheet in such a manner that the valve element sheet is disposed inside. A fifth step is to shift a downstream side end in one of the valve element sheets and a downstream side end in at least one of the other valve element sheets in the superposed state from each other with respect to a direction of an air current. A sixth step is to form a bag side seal and a sealed portion partitioning seal in order to define the sealed portion, and to form an order to define the air vent passage. In the former step, the seals are provided to bond the bag sheets integrally with each other in portions other than an opening portion for putting in and out of an article and a portion coupling the sealed portion and the air vent passage and of the sealed portion. In the latter step, the seal is obtained by bonding the bag sheets and the valve element sheet integrally with each other and extended in a direction along the air current in the forward direction.

### BRIEF DESCRIPTION OF THE DRAWINGS

FIG. 1 is a plan view showing a compression bag according to an example of an embodiment in accordance with the present invention;

FIG. 2 is an end view taken along an A-A line in FIG. 1A, illustrating a part in a longitudinal direction with an exaggeration, where FIG. 2A shows a state in which an air vent passage is opened and FIG. 2B shows a state in which the air vent passage is closed;

FIG. 3 is an exploded perspective view showing a structure of the compression bag according to the example of the embodiment in accordance with the present invention;

FIG. 4 is a plan view showing a compression bag according to another example of the embodiment in accordance with the present invention;

FIGS. 5A to 5C are explanatory views showing an air vent passage of the compression bag according to the another example of the embodiment in accordance with the present invention as seen from an end face respectively;

FIGS. 6A and 6B are explanatory views showing a structure of a bag sheet to be used in the compression bag according to the another example of the embodiment in accordance with the present invention respectively;

FIGS. 7A and 7B are explanatory views showing an air vent passage in the compression bag according to the another example of the embodiment in accordance with the present invention as seen from the end face respectively;

FIG. 8A is an explanatory view showing a process for manufacturing a compression bag according to an example of the embodiment in accordance with the present invention as seen on a plane and FIG. 8B is an explanatory view showing the process as seen from a front;

FIG. 9A is a plan view showing a compression bag according to an example of an embodiment in accordance with a related art, FIG. 9B is an end view taken along B-B line in FIG. 9A, and FIG. 9C is an explanatory view showing a structure of a check valve according to another example of the embodiment in accordance with the related art as seen from an end face;

FIG. 10 is an exploded perspective view showing a structure of a compression bag according to another example of the embodiment in accordance with the related art;

FIG. 11A is a plan view showing the compression bag according to the example of the embodiment in accordance with the present invention which is subjected to an experiment, and FIG. 11B is a plan view showing a compression bag to be a comparing object; and

FIGS. 12A and 12B are plan views showing the compression bag to be the comparing object in the experiment.

### DETAILED DESCRIPTION OF THE PREFERRED EMBODIMENTS

Description will be given by taking a compression bag as an example of a sealed bag according to an embodiment of the present invention.

Expressions indicative of a position and a direction such as “longitudinal”, “vertical and lateral” and “transverse” described in the claims and the specification of the present invention are determined for convenience based on states shown in the drawings in order to specify the position, and the present invention should not be construed to be restricted to a positional relationship which will be described below.

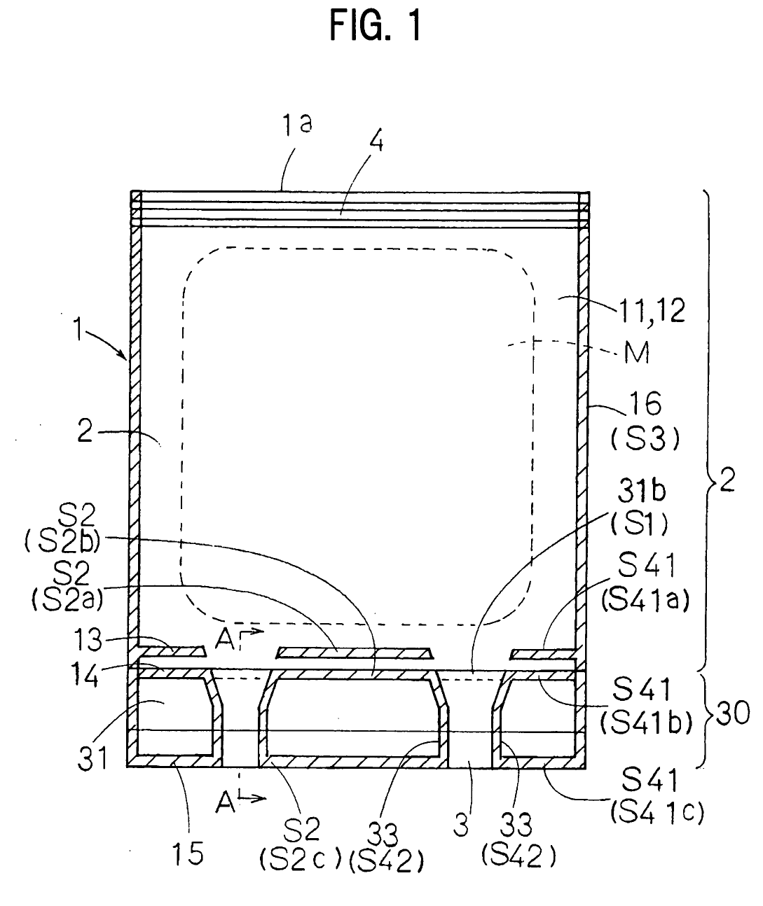

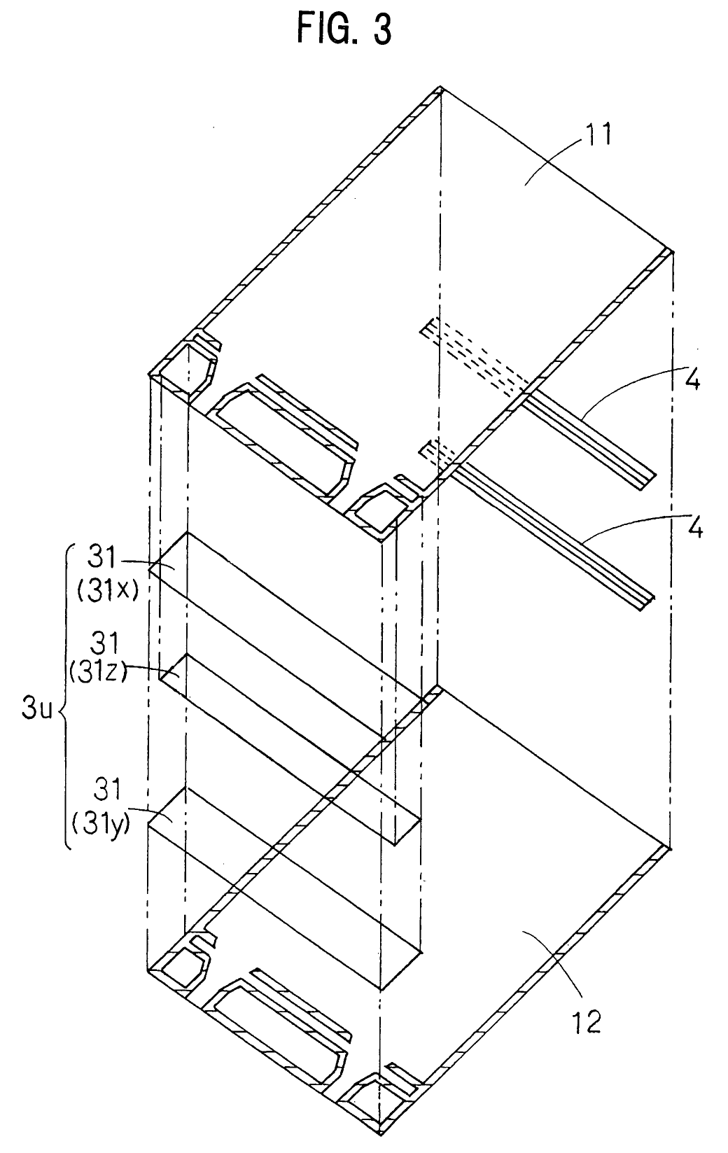

In a compression bag 1 according to the present example, as shown in FIGS. 1 and 3, a bag sheet having a shape of a vertically-long rectangle shown in the figures (a front bag sheet 11 and a rear bag sheet 12) and a valve element sheet 31 having a shape of a horizontally-long rectangle and having a smaller longitudinal dimension than the bag sheets 11 and 12 (a front valve element sheet 31x, a rear valve element sheet 31y and an intermediate valve element sheet 31z) are used as components, respectively.

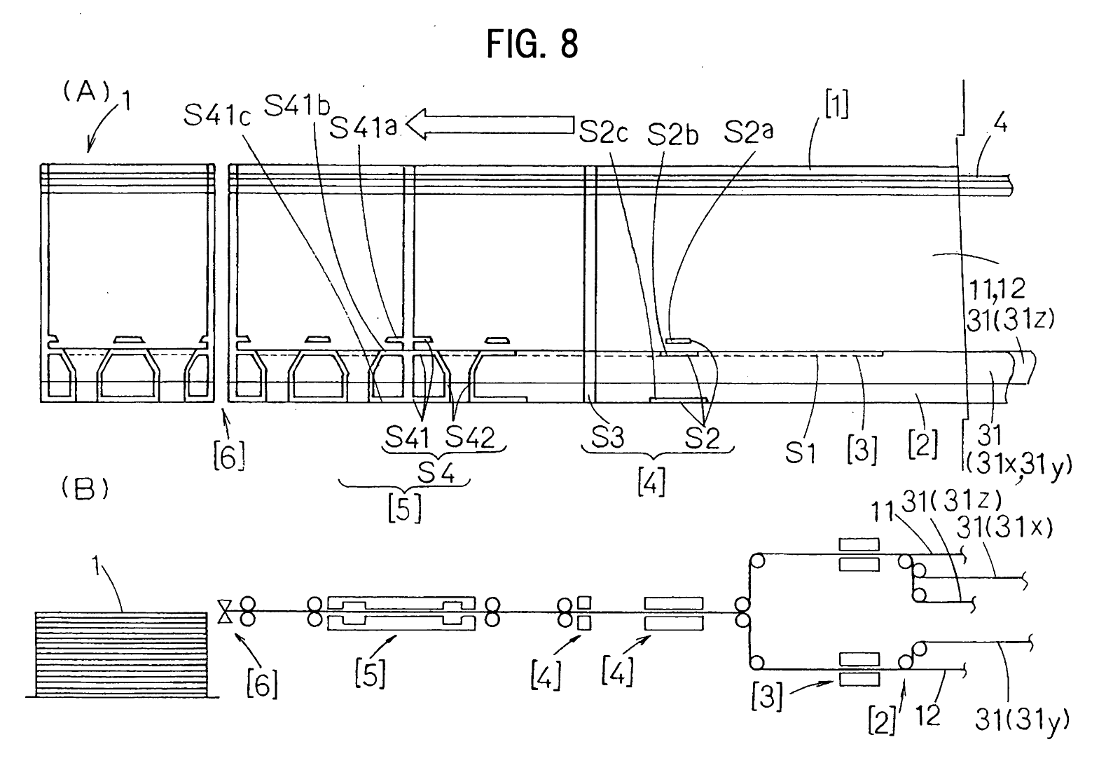

The sheets 11, 12 and 31 as the components have flexibility, and an elongated sheet which is continuous in a longitudinal direction is used as shown in FIG. 8. As will be described below, predetermined positions of the respective sheets 11, 12 and 31 are bonded through heat sealing or the like, and are cut to form a bag member in which a sealed portion 2 and an air vent passage 3 are partitioned. A sheet made of a resin is used for the sheets 11, 12 and 31. Examples of the sheet made of a resin can include a sheet obtained by bonding and laminating a plurality of resin films, for example, a plurality of polyethylene films and a sheet obtained by bonding and laminating a polyethylene film and a nylon film. The sheet thus obtained by laminating the resin films is more general than a sheet formed by a uniform material. Moreover, the polyethylene film has a heat sealing property. However, the nylon film does not have the heat sealing property. For this reason, it is necessary to carry out the heat sealing by opposing the polyethylene films in the sheet made of a resin to each other as will be described below.

As shown in FIG. 3, an outer portion of the compression bag 1 is constituted by the bag sheets 11 and 12 disposed opposite to each other in a longitudinal direction. The sealed portion 2 is formed between the front bag sheet 11 and the rear bag sheet 12 and is set to have a space capable of accommodating an article M. Moreover, the air vent passage 3 is provided with an air current passage space 3a which is continuous from the sealed portion 2 to the outside of the bag in such a manner that a gas (air) passes in the deaeration from an inner space of the sealed portion 2 to the outside of the bag.

With reference to FIG. 1, description will be further given. The sealed portion 2 according to the example is obtained by integrally bonding the bag sheets 11 and 12 that are superposed and oriented in a longitudinal direction and the valve element sheet 31, and is an upper portion from a sealed portion partitioning seal 14 extended in a transverse direction which is defined by the sealed portion partitioning seal 14 and a bag side seal 16 defining both of left and right ends of the sealed bag 1, and the air vent passage 3 is defined by an air vent passage side seal 33 which will further be described below in an air vent passage forming portion 30 to be a lower part defined by the sealed portion partitioning seal 14.

As a matter of course, the sealed portion partitioning seal 14 is not provided between the sealed portion 2 and the air vent passage 3. In the example, a bottom seal 15 formed to define a lower end of the sealed bag 1 is not provided in the air vent passage 3 portion. For this reason, a space in the sealed portion 2 and the air current passage space 3a of the air vent passage 3 communicate with each other, so that the gas (air) present in the sealed portion 2 can be discharged to the outside of the bag.

While the sealed portion partitioning seal 14 is formed in superposition with a bonding portion 31b which is a seal obtained by bonding the bag sheets 11 and 12 to the valve element sheet 31 at the same position in a vertical direction as shown in the figure in the present example, it is sufficient that at least the front bag sheet 11 and the rear bag sheet 12 are bonded integrally with each other and the sealed portion partitioning seal 14 may be shifted from the bonding portion 31b.

As shown in FIG. 1, upper end sides of the front bag sheet 11 and the rear bag sheet 12 are not bonded to each other, so that an opening portion 1a is formed. The article M can be put in/out of the sealed portion 2 through the opening portion 1a. In the present example, the opening portion 1a is provided with a closing unit 4. The opening portion 1a can be closed in an airtight state. For the closing unit 4 according to the present example, there is employed a fastener made of a resin which has such a structure that a convex portion is provided in one of the bag sheets 11 and 12 and a concave portion is provided in the other, and the opening portion 21 can be closed by fitting the convex and concave portions. The closing unit 4 is not limited thereto, and various members can be used. Depending on the circumstances, it is also possible to accommodate the article M in the sealed portion 2 through the opening portion 1a and to then bond the opening portion 1a by heat sealing or the like, thereby bringing the sealed portion into an unopenable state. In the sealed bag 1 having such a configuration that the sealed portion 2 is filled with a gas through the air vent passage 3 for use, the opening portion 1a is not provided at the beginning but only the air vent passage 3 may be set to be a portion capable of passing the gas therethrough.

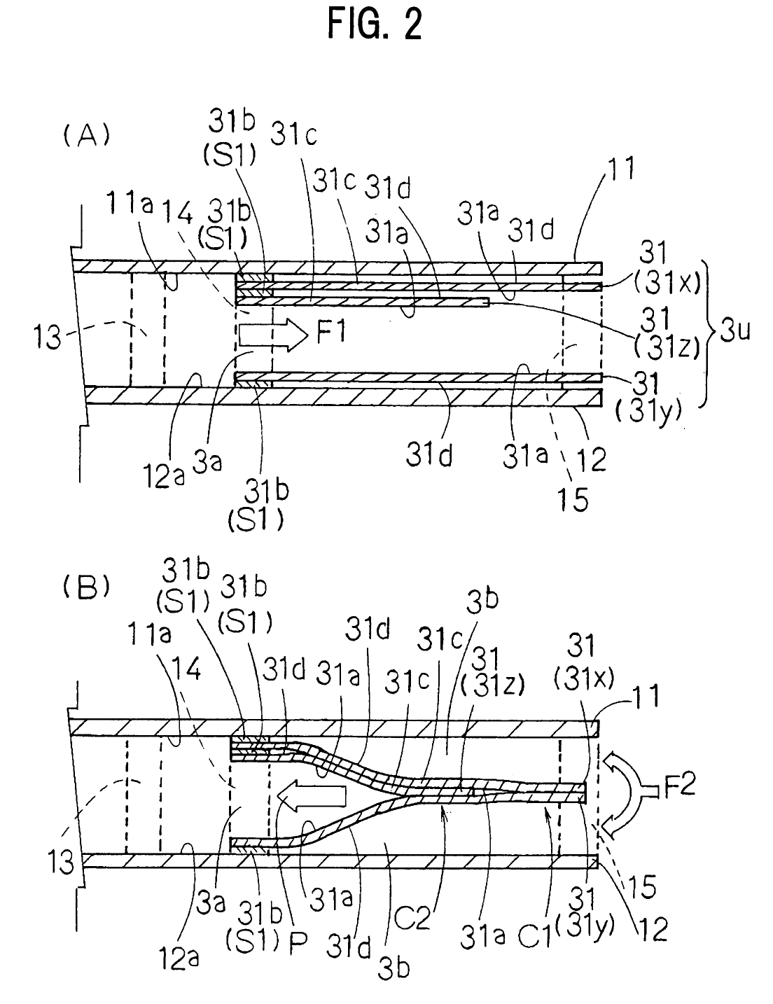

In the present example, the valve element sheet 31 is a lower part of the compression bag 1 and is provided in the air vent passage forming portion 30 to be a lower portion which is defined by the sealed portion partitioning seal 14 as shown in FIG. 1. As shown in FIGS. 2A and 3, three valve element sheets 31 (31x, 31y and 31z) are superposed in a longitudinal direction between the front bag sheet 11 and the rear bag sheet 12, that is, a direction of a thickness of the sheet. In the description, a set of valve element sheets 31 (31x, 31y and 31z) thus superposed is referred to as a valve unit 3u.

In the air vent passage 3, the air current passage space 3a which is continuous from the inner part of the sealed portion 2 to the outside of the compression bag 1 is opened in the deaeration. In the present example, the air current passage space 3a is set to be a space as shown in FIG. 2A between the valve element sheets 31, more specifically, between the front valve element sheet 31x and the rear valve element sheet 31y on the lower side of the air vent passage 3 and between the intermediate valve element sheet 31z and the rear valve element sheet 31y on the upper side of the air vent passage 3. FIG. 2 shows the front bag sheet 11 and the rear bag sheet 12 which are separated from each other by a considerable distance in order to facilitate understanding of the air vent passage 3. However, the front bag sheet 11 and the rear bag sheet 12 are stuck to each other with the valve element sheet 31 interposed therebetween as shown in FIG. 3. For this reason, they are actually closer to each other (this is true for the other explanatory views showing the air vent passage 3 as seen from an end face). Accordingly, inner surfaces 11a and 12a of the bag sheets 11 and 12 are close to each other so as to contact in a portion where the valve element sheet 31 is not present, and the valve element sheets 31 (31x, 31y and 31z) opposed to each other are close to each other so as to contact in a portion where the valve element sheet 31 is present. Only when an air current passes from the sealed portion 2 to the outside of the bag (an air current F1 in a forward direction), the valve element sheets 31 (31x, 31y and 31z) are separated from each other so that the air current passage space 3a is opened.

As shown in FIG. 1, in four directions of the air current passage 3, an upper side, a lower side, and left and right sides are defined respectively by the sealed portion 2, a lower end side of the compression bag 1, and two air vent passage side seals 33 formed in a longitudinal direction to bond the bag sheets 11 and 12 and the valve element sheet 31 integrally with each other. The upper end is conducted to the sealed portion 2, and the lower end is coincident with the lower end of the sealed bag 1 and is conducted to the outside of the bag.

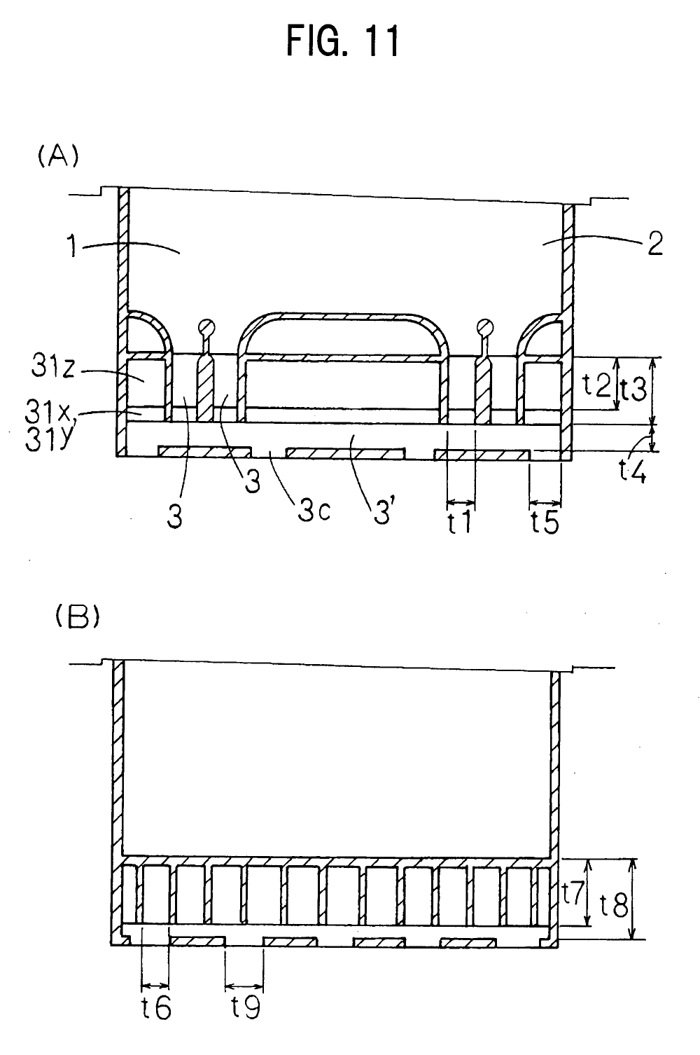

Although the air vent passage 3 is provided in two places in the compression bag 1 according to the present example, it is not limited thereto, and may be provided in only one place or three places or more. As shown in FIG. 11A, a plurality of air vent passages 3 may be formed continuously in parallel with each other by sharing an air vent passage side seal 33.

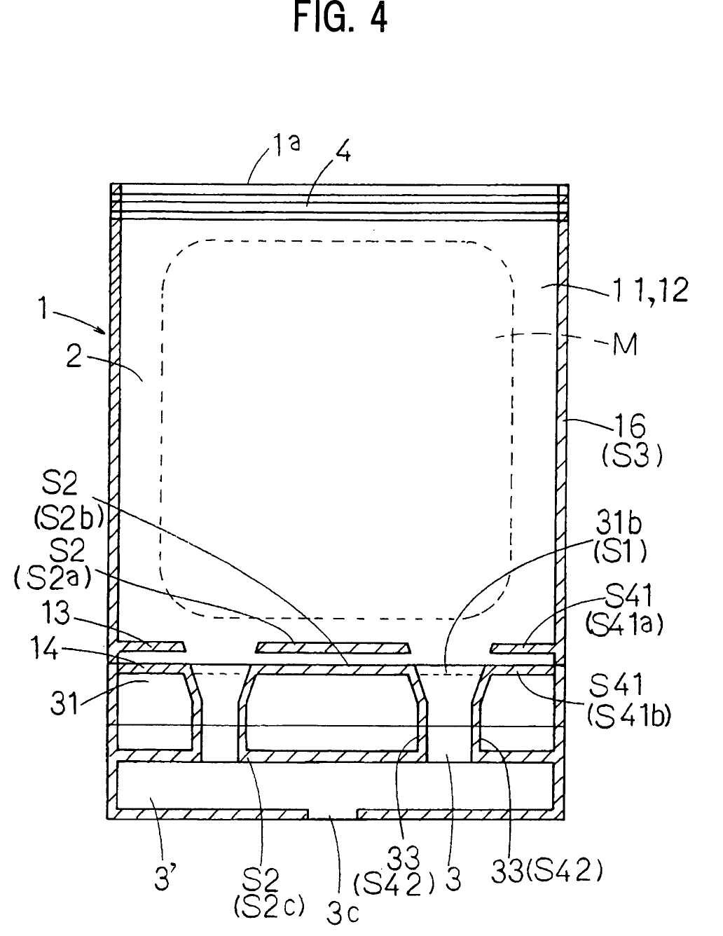

As shown in FIG. 4, furthermore, an extended air vent passage 3′ communicating with the air vent passage 3 may be provided on the lower side of the compression bag 1 and a deaeration port 3c for carrying out deaeration to the outside of the bag may be intensively provided in the extended air vent passage 3′.

In the present example, part of the front side valve element sheet 31x provided on the front side (an upper side in FIG. 2A) is bonded to the inner surface 11a of the front bag sheet 11. Part of the rear side valve element sheet 31y on the rear side (a lower side in FIG. 2A) is bonded to the inner surface 12a of the rear bag sheet 12. The intermediate valve element sheet 31z provided between the front side valve element sheet 31x and the rear side valve element sheet 31y is bonded to a surface on the side of the air current passage space 3a of the front side valve element sheet 31x.

In the present example, the front side valve element sheet 31x and the rear side valve element sheet 31y have longitudinal dimensions which are equal to each other, and the intermediate valve element sheet 31z has a longitudinal dimension which is smaller than the longitudinal dimensions of the front side valve element sheet 31x and the rear side valve element sheet 31y.

In each of the valve element sheets 31, the portion bonded as described above is the bonding portion 31b. The bonding portion 31b is provided on an upstream side of the valve element sheet 31 (which is based on the air current F1 in the forward direction and so forth). In the present example, the bonding portion 31b is an end of the valve element sheet 31 which is provided on the side of the sealed portion 2. In other words, the front side valve element sheet 31x is bonded to the front bag sheet 11 only in the bonding portion 31b and the air vent passage side seal 33, and the rear side valve element sheet 31y is bonded to the rear bag sheet 12 only in the bonding portion 31b and the air vent passage side seal 33. Moreover, the intermediate valve element sheet 31z is bonded to the front side valve element sheet 31x only in the bonding portion 31b and the air vent passage side seal 33.

The valve element sheets 31 (31x to 31z) are disposed in such a manner that ends on the sealed portion 2 side are aligned with each other, and the bonding portions 31b are coincident with each other in a vertical direction as shown in FIG. 2A. As described above, the intermediate valve element sheet 31z is formed to have a smaller longitudinal dimension than the longitudinal dimensions of the front side valve element sheet 31x and the rear side valve element sheet 31y. On a downstream side in the air current F1 in the forward direction, therefore, an end on the downstream side of the intermediate valve element sheet 31z is disposed close to the upstream side as compared with ends on the downstream side of the front side valve element sheet 31x and the rear side valve element sheet 31y (the lower end shown in FIG. 1).

The downstream side of the bonding portion 31b in the valve element sheet 31 is a movable portion 31c. The movable portion 31c can be moved within a range from a state in which the air current passage space 3a is opened and the air current F1 in the forward direction can pass as shown in FIG. 2A to a state in which the air current passage space 3a is closed as shown in FIG. 2B. As shown in FIG. 2B, consequently, the movable portion 31c of the valve element sheet 31 (for example, the front side valve element sheet 31x) floats with respect to the front bag sheet 11 and the rear bag sheet 12 to which the valve element sheet 31 is bonded and adheres to another valve element sheet 31 (for example, the rear side valve element sheet 31y), so that the air current passage space 3a can be closed.

In the movable portion 31c of the valve element sheet 31, a surface on an opposed side to the bag sheets 11 and 12 at the side where the valve element sheets 31 (in the present example, the front side valve element sheet 31x and the rear side valve element sheet 31y) to which the movable portion 31c belongs is bonded or another valve element sheet 31 (in the example, the front side valve element sheet 31x) on the side where the valve element sheet 31 (in the present example, the intermediate valve element sheet 31z) to which the movable portion 31c belongs is bonded is a separated surface 31d. The adhering surface 31a is provided on an opposite side of the separated surface 31d. As shown in FIG. 2B, when the air current passage space 3a is closed, the adhering surface 31a of one of the valve element sheets 31 adheres to the adhering surface 31a of the other valve element sheet 31.

The portion in which the bonding portion 31b is formed is not restricted to the end on the sealed portion 2 side of the valve element sheet 31 in present the example but may be formed apart from the end of the valve element sheet 31. Accordingly, portions which are not bonded to the bag sheets 11 and 12 other than the movable portion 31c may be provided so as not to inhibit the deaeration.

In the present example, moreover, the longitudinal dimensions of the front side valve element sheet 31x and the rear side valve element sheet 31y are equal to each other, and the longitudinal dimension of the intermediate valve element sheet 31z is smaller than the longitudinal dimensions of the front side valve element sheet 31x and the rear side valve element sheet 31y. However, it is also possible to shift the ends of the valve element sheets 31 from each other by forming all of the sheets 31x to 31z to have equal longitudinal dimensions and shifting the position of the bonding portion 31b.

In the present example, the front side valve element sheet 31x and the intermediate valve element sheet 31z are superposed and disposed on the front side of the air current passage space 3a (on an upper side shown in FIG. 2). As described above, the end on the downstream side of the intermediate valve element sheet 31z is disposed close to the upstream side of the air vent passage 3 as compared with the ends (the lower ends shown in FIG. 1) on the downstream side of the front side valve element sheet 31x and the rear side valve element sheet 31y. When the air current passage space 3a is closed, the adhering surfaces 31a of the front side valve element sheet 31x and the rear side valve element sheet 31y adhere to each other in a first adhering portion C1. Furthermore, the adhering surfaces 31a of the intermediate valve element sheet 31z and the rear side valve element sheet 31y adhere to each other in a second adhering portion C2. In other words, the first adhering portion C1 and the second adhering portion C2 which serve to close the air current passage space 3a are present in two different places which are shifted relatively in a vertical direction per valve unit 3u set. Therefore, the air current passage space 3a is first closed in the second adhering portion C2 with the intermediate valve element sheet 31z and the rear side valve element sheet 31y, and is further closed in the first adhering portion C1 with the front side valve element sheet 31x and the rear side valve element sheet 31y on a downstream side. Thus, the air current passage space 3a is closed doubly in a serial direction to the direction of the air current. Consequently, a checking effect can be obtained more reliably. In the case where the compression bag 1 has a large size and the size of the air vent passage 3 is also increased in proportion thereto, particularly, a great effect can be exhibited.

The shift of the positions of the ends in the valve element sheets 31 is set to 3 mm to 20 mm, more desirably, 5 mm to 15 mm.

It is important that a combination of the valve element sheets 31 constituting the adhering portions C1 and C2 is different. In the case where two valve element sheets simply adhere to each other so that the air current passage space 3a is closed, there is a possibility that the valve element sheets might be wrinkled to generate leakage. In the case where the combination of the valve element sheets 31 constituting the adhering portions C1 and C2 is different as in the present invention, however, one of the adhering portions may be prevented from directly influenced by a defect such as leakage caused by, for example, the wrinkles of the valve element sheet in the other adhering portion. Also for this reason, it is apparent that the structure of the air vent passage according to the present invention is excellent.

Although a set of the valve unit 3u is constituted by the three valve element sheets 31 including the front side valve element sheet 31x, the rear side valve element sheet 31y and the intermediate valve element sheet 31z in the present example, the structure of the valve unit 3u is not limited thereto.

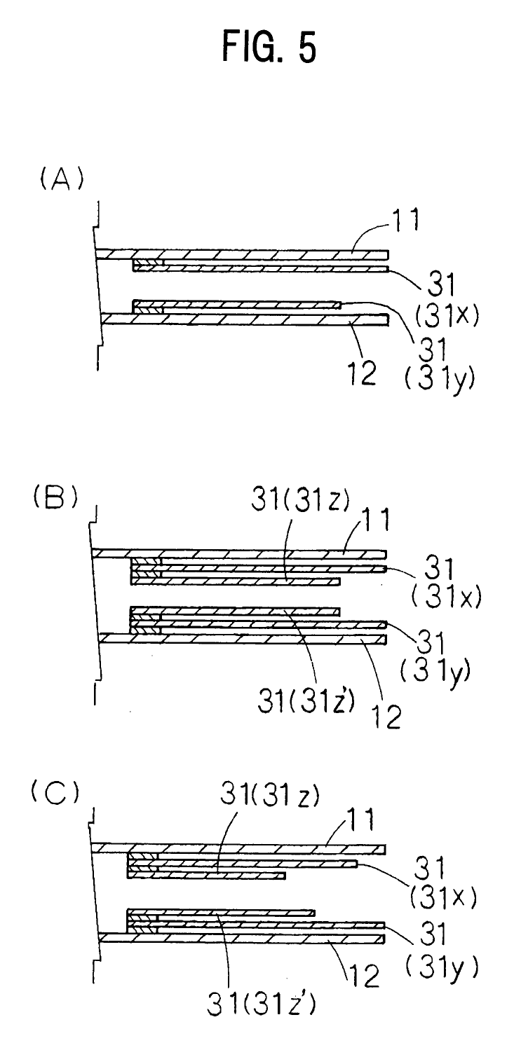

For example, as shown in FIG. 5A, it is also possible to constitute the set of the valve unit 3u by two valve element sheets 31 including the front side valve element sheet 31x and the rear side valve element sheet 31y having a longitudinal dimension which is smaller than that of the front side valve element sheet 31x. In this case, the air current passage space 3a is closed in the first adhering portion C1 with the front side valve element sheet 31x and the rear side valve element sheet 31y, and furthermore, is closed in the second adhering portion C2 with the front side valve element sheet 31x and the rear bag sheet 12 on the downstream side.

As shown in FIGS. 5B and 5C, moreover, it is also possible to constitute the set of the valve unit 3u by at least four valve element sheets 31. Furthermore, the number of the adhering portions may be three or more for the set of the valve unit 3u.

In addition, at least two sets of the valve unit 3u may be provided in the serial direction to the direction of the air current.

When the air current passage space 3a of the air vent passage 3 is closed, the inner part of the sealed portion 2 is brought into a depressurized state with the deaeration so that the adherence of the valve element sheet 31 is carried out in the case of the compression bag 1 which is used by discharging the air from the sealed portion 2. In other words, a pressure difference is made between the outside of the bag (a positive pressure) and the inner part of the sealed portion 2 (a negative pressure) Based on the pressure difference, sucking force P for attraction to the sealed portion 2 side which is the negative pressure side acts on the valve element sheet 31 as shown in FIG. 2B. Since the valve element sheet 31 is made of a resin having flexibility, it is easily deformed by the sucking force, so that parts of the adhering surfaces 31a of the valve element sheets 31 adhere to each other. At the same time, the outside air is prevented from flowing back to the sealed portion 2, and always enters a dead end portion 3b between the bag sheets 11 and 12 and the valve element sheet 31 and stays therein. Accordingly, it is impossible to cause a situation in which the air current passage space 3a is not closed and the air current F2 in a backward direction continuously flows back to the sealed portion 2 in this state. Thus, the air current passage space 3a can be closed reliably.

Contrary to the compression bag 1 according to the present example, in the case of the sealed bag 1 having such a configuration that the sealed portion 2 is filled with a gas, the pressure inside the sealed bag 2 is higher than that of the outside of the bag and a pressure difference opposite from that described above is made. Based on the pressure difference, the adhering surfaces 31a of the valve element sheets 31 adhere to each other in the same manner as described above. At the same time, the gas filled in the sealed portion 2 does not flow back to the outside of the bag, and always enters the dead end portion 3b and stays therein. Therefore, the air current passage space 3a can be closed reliably.

On the other hand, the air current F1 in the forward direction to flow to the outside of the sealed portion 2 which is reverse to that described above expands a portion between the two valve element sheets 31 and opens the air current passage space 3a to flow as shown in FIG. 2A.

With the structure of the air vent passage 3 according to the present invention, as will be described later, a heated metal mold for heat sealing is not pressed against the air vent passage 3. Therefore, it is possible to set the resistance in the deaeration to be as small as possible. Consequently, it is not necessary to apply an extra force for removing a lightly heat sealed portion even in the case where the valve element sheets 31 are lightly heat sealed by the heat in the heat sealing and by the pressure of the metal mold for carrying out the heat sealing and the air current F1 in the forward direction is caused to pass through the air vent passage 3 as in the conventional problem. According to the present invention, therefore, the aeration can be easily carried out almost without resistance even in the case where people having comparatively weak strength such as children and elderly people use the compression bag 1 when pressing the sealed portion 2 by hands to discharge the air present in the sealed portion 2 to the outside of the compression bag 1. Moreover, the sealed portion 2 can be prevented from bursting.

By setting the separated surface 31d on the opposite side of the adhering surface 31a in the valve element sheet 31 to have a hard-to-adhere property compared to the adhering surface 31a, it is also possible to cause the valve element sheet 31 to float easily with respect to the bag sheets 11 and 12 to which the valve element sheet 31 is bonded. For example, it is possible to use a material having a poorer adhering property than other resin films for any of the plurality of resin films constituting the valve element sheets 31 that forms the separated surface 31a, to carry out satin finishing over the separated surface 31d thereby forming irregularities, or to apply a coating material for enhancing a peeling property of the separated surface 31d.

On the other hand, it is desirable that the adhering surface 31a should have an easy-to-adhere property in order to effectively close the air vent passage 3 in contrast to the above. For example, by using a material having a higher adhering property than the other resin films, that is, a so-called blocking property, for any of the plurality of resin films constituting the valve element sheet 31 that forms the adhering surface 31a, or by putting an inert liquid such as silicone oil in such an amount as not to inhibit the deaeration onto the adhering surface 31a, it is possible to cause the valve element sheets 31 to easily adhere to each other, thereby preventing a backward flow of the air in the air vent passage 3 effectively.

Moreover, it is also possible to use, for the valve element sheet 31, a sheet capable of absorbing a liquid such as a nonwoven fabric, thereby soaking an inert liquid such as silicone oil into the valve element sheet 31. Consequently, it is possible to enhance the blocking property by utilizing surface tension of the soaked liquid.

While the bag sheets 11 and 12 and the valve element sheet 31 are formed by the separate sheets in the foregoing description, they are not limited thereto, and the front bag sheet 11 and the valve element sheet 31, or the rear bag sheet 12 and the valve element sheet 31 may be integrated with each other. In other words, the structure of at least one of the bag sheets 11 and 12 may be partially used as the valve element sheet 31.

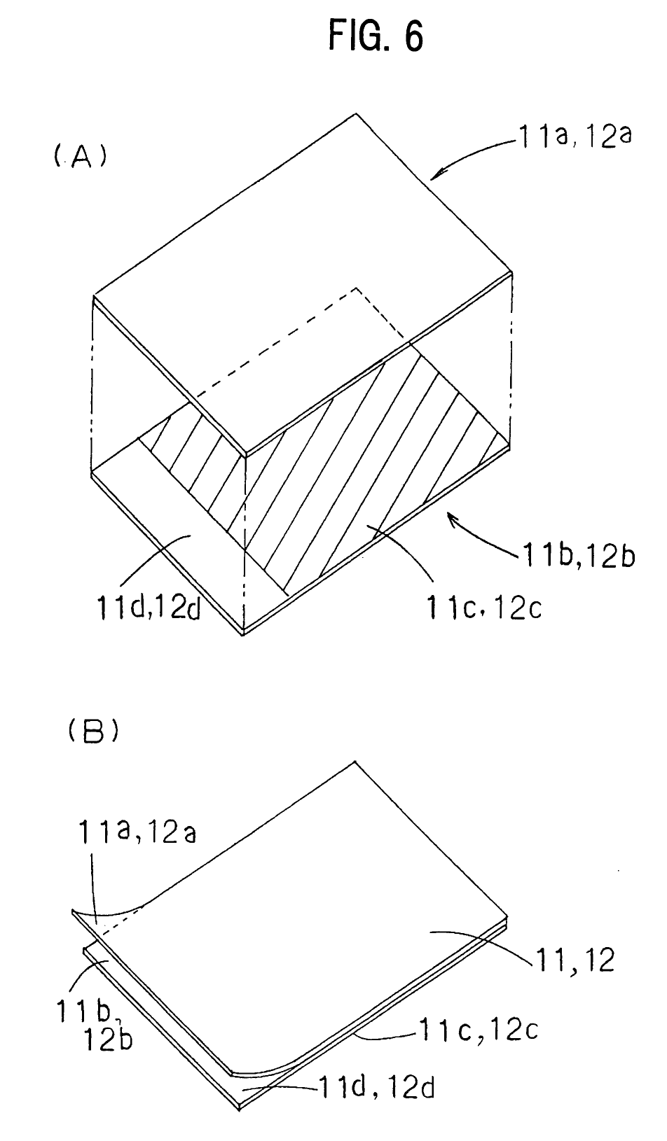

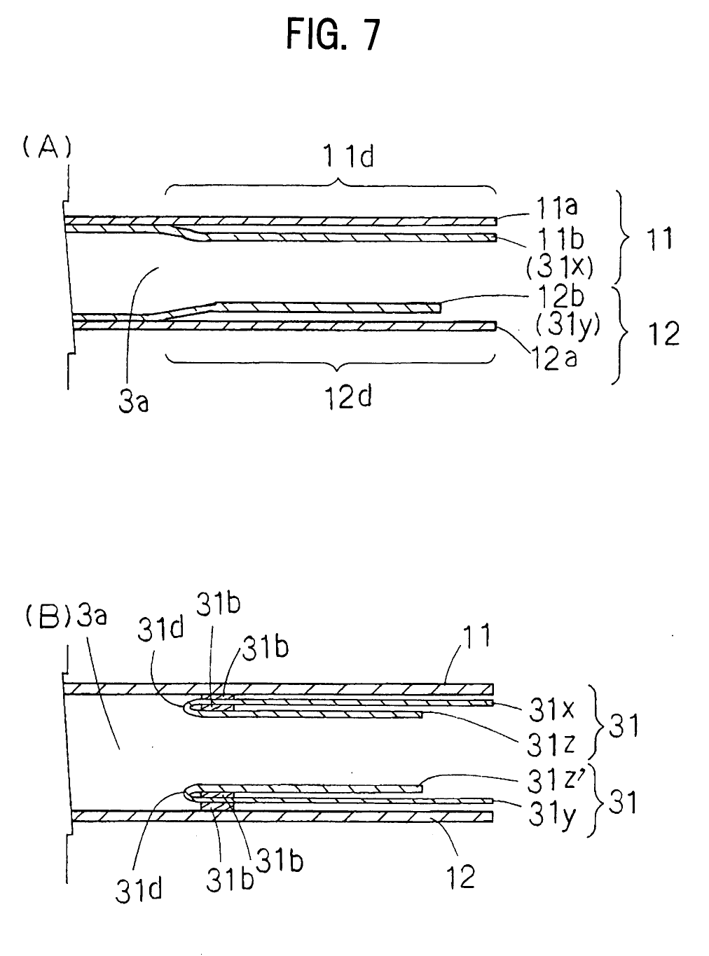

The bag sheets 11 and 12 are obtained by bonding and laminating a plurality of resin films such as a polyethylene film or a nylon film. In outer resin films 11a and 12a and inner resin films 11b and 12b which constitute the bag sheets 11 and 12, an adhesive is applied to bonding portions 11c and 12c and is not applied to non-bonding portions lid and 12d to be ends of the bag sheets 11 and 12, and they are superposed as shown in FIG. 6A. Consequently, it is possible to bring about a state in which the outer resin films 11a and 12a and the inner resin films 11b and 12b are separated from each other only in the non-bonding portions 11d and 12d as shown in FIG. 6B. The non-bonding portions 11d and 12d are used as the air vent passage 3 of the compression bag 1. In other words, in the case where the outer resin films 11a and 12a are positioned on the outside of the compression bag 1 as shown in FIG. 7A, the outer resin films 11a and 12a are used as one corresponding to the front bag sheet 11 shown in FIG. 2A and the inner resin films 11b and 12b are used as one corresponding to the valve element sheets 31 (31x and 31y) shown in FIG. 2A, more specifically, the movable portion 31c of the valve element sheet. As shown in FIG. 7A, it is necessary to cut the inner resin films 11b and 12b in such a manner that the positions of the ends on one side and the other side can be placed to be shifted to the upstream and downstream sides in the direction of the air current.

Also in the case where the front bag sheet 11 and the rear bag sheet 12 are constituted by a resin film having three layers or more, a non-bonding portion similar to that described above is provided in at least one place in the layers of each film. In the same manner as in the resin film having two layers described above, consequently, a resin film (layer) present on an outside is used as one corresponding to the front bag sheet 11 shown in FIG. 2A and a resin film (layer) present on an inside or a middle part can be used as one corresponding to the valve element sheet 31 shown in FIG. 2A.

Regarding the bonding of the resin film, it is possible to select various processing methods such as wet lamination, extrusion coating and lamination, dry lamination and non-solvent lamination.

Although the valve element sheet 31 is formed by three planar sheets and each of them is attached to the front bag sheet 11 and the rear bag sheet 12 in the present example, it is also possible to employ a structure in which one valve element sheet 31 is folded in such a manner that one side is wide and the other side is narrow with a folding line 31d set as a boundary, the bag sheets 11 and 12 are attached with the folding line 31d being orthogonal to the direction of the air current, and the ends of the valve element sheet 31 are disposed with a shift in the direction of the air current as shown in FIG. 7B, for example. In this case, regarding the valve element sheet 31 on the front side (the upper side in the figure), the wide folded side is used as the front side valve element sheet 31x and the narrow folded side is used as the intermediate valve element sheet 31z. Regarding the valve element sheet 31 on the rear side (the lower side in the figure), the wide folded side is used as the rear side valve element sheet 31y and the narrow folded side is used as the intermediate valve element sheet 31z′.

In addition to the above description, the configuration of the sealed bag 1 can be changed variously.

Next, description will be given on a manufacturing method by taking, as an example, the compression bag 1 shown in FIG. 1. In order to manufacture the compression bag 1 according to the present example, a flexible sheet which is continuous in a longitudinal direction is used for the bag sheets 11 and 12 and the valve element sheet 31 and is consecutively supplied in each step which will be described below, and processes such as heat sealing and cutting are sequentially performed as shown in an arrow of FIG. 8.

First of all, a closing member 4 is attached through heat sealing to the upper end portion in the figure, which is a portion to be the opening portion 1a of the compression bag 1 when finished, in each of the front bag sheet 11 and the rear bag sheet 12 (Step [1]). The closing member 4 is a fastener in which a convex portion is disposed on one of the bag sheets 11 and 12 and a concave portion is disposed on the other in the present example, and is supplied continuously in a longitudinal direction in each step in the same manner as the sheets 11, 12 and 31.

Simultaneously with the attachment of the closing member 4, the valve element sheet 31 is superposed on each of the front bag sheet 11 and the rear bag sheet 12 (Step [2]). The front side valve element sheet 31x and the intermediate valve element sheet 31z are superposed on the front bag sheet 11, and the rear side valve element sheet 31y is superposed on the rear bag sheet 12.

In the case where one valve element sheet 31 is folded in such a manner that one side is wide and the other side is narrow and is attached to the bag sheets 11 and 12 in that state as shown in FIG. 7B, the valve sheet 31 which is previously folded is superposed on the bag sheets 11 and 12.

The valve element sheet 31 is bonded to the front bag sheet 11 or rear bag sheet 12 superposed as described above by applying a valve element bonding seal S1 through the heat sealing (Step [3]). A portion to which the valve element bonding seal S1 is applied in the valve element sheet 31 is the bonding portion 31b shown in FIG. 1.

In the state described above, the front bag sheet 11 and the rear bag sheet 12 are separated from each other so that the valve element sheet 31 bonded to the front bag sheet 11 (the front side valve element sheet 31x and the intermediate valve element sheet 31z) and the valve element sheet 31 bonded to the rear bag sheet 12 (the rear side valve element sheet 31y) are prevented from being influenced by the heat of the heat sealing and the pressure of the metal mold for carrying out the heat sealing.

As described above, next, the front bag sheet 11 and the rear bag sheet 12 to which the valve element sheet 31 is bonded are superposed in such a manner that the valve element sheets 31 are opposed to each other. In other words, they are superposed in such a manner that the valve element sheets 31 are disposed inside. A central side seal S2 and a bag side seal S3 (16) are collectively formed and bonded to the sheets 11, 12 and 31 which are superposed (Step [4]).

The central side seal S2 is positioned at a central part in the vicinity of the valve element sheet 31 and is formed in a longitudinal direction (a transverse direction shown in the figure) in a state where the compression bag 1 is finished. In the present example, three rows are arranged in a vertical direction in the figure. An upper central side seal S2a serves to rectify the air current F1 in the forward direction and to reinforce the front bag sheet 11 and the rear bag sheet 12, and constitutes a portion in a reinforcing seal 13 shown in FIG. 1 which is interposed between two air vent passages 3. An intermediate central side seal S2b serves to partition the sealed portion 2 and the air vent passage 3 and constitutes a portion of a sealed portion partitioning seal 14 shown in FIG. 1 which is interposed between the two air vent passages 3. A lower central side seal S2c serves to define the lower end of the compression bag 1 and to integrally bond the respective sheets 11, 12 and 31, and constitutes a portion of a bottom seal 15 shown in FIG. 1 which is interposed by the two air vent passages 3.

The bag side seal S3 (16) serves to define both left and right ends (both ends in the longitudinal direction based on the sheets 11, 12 and 31) of the compression bag 1 and to bond the sheets 11, 12 and 31 integrally with each other.

Next, a lateral side seal S4 is formed on the lateral side in the figure of the central side seal S2 formed as described above (Step [5]). The lateral side seal S4 is constituted by a lateral seal S41 and a vertical seal S42. The lateral seal S41 is formed in a longitudinal direction (the lateral direction in the figure) and three rows are arranged in the vertical direction in the figure and have the same function as the central side seal S2 in the present example. In other words, an upper lateral seal S41a serves to rectify the air current F1 in the forward direction and to reinforce the front bag sheet 11 and the rear bag sheet 12, and constitutes an end side portion of the bag from the two air vent passages 3 in the reinforcing seal 13 shown in FIG. 1. An intermediate lateral seal S41b serves to partition the sealed portion 2 and the air vent passage 3 and constitutes an end side portion of the bag from the two air vent passages 3 in the sealed portion partitioning seal 14 shown in FIG. 1. A lower lateral seal S41c serves to define the lower end of the compression bag 1 and to bond the respective sheets 11, 12 and 31 integrally with each other, and constitutes an end side portion of the bag from the two air vent passages 3 in the bottom seal 15 shown in FIG. 1.

More specifically, the vertical seal S42 is the air vent passage side seal 33 described above, and is positioned on both of the left and right sides of the air vent passage 3 and is formed in the vertical direction in FIG. 1 in the state where the compression bag 1 is finished. Accordingly, the left and right sides of the air vent passage 3 are defined by the vertical seal S42. The upper end of the air vent passage 3 is defined by a position on an extended line of the intermediate central side seal S2b and the intermediate lateral seal S41b of the lateral seal S4. In other words, the upper end of the vertical seal S42 which is close to the sealed portion 2 is formed to be linked to the intermediate central side seal S2b and the intermediate lateral seal S41b which form the sealed portion partitioning seal 14.

While the position of the upper end of the air vent passage 3 is coincident with the positions of the upper end of the valve element sheet 31 and the valve element bonding seal S1 in the present example, it may be shifted therefrom and various changes can be made. Moreover, the lower end of the air vent passage 3 is defined by the lower ends of the bag sheets 11 and 12 in the present example.

Each of the seals S1 to S4 described above is formed by pressing the heated metal mold against the respective sheets 11, 12 and 31. The respective seals S1 to S4 are formed in the procedure described above. In a portion corresponding to a position through which an air current passes in the air vent passage 3, therefore, the metal mold is not pressed against the respective sheets 11, 12 and 31 and the heat sealing is not carried out at all. Consequently, a situation does not occur in which an extra force is needed to open the air vent passage 3 as the valve element sheets 31 are lightly bonded to each other by the heat in the heat sealing and the pressure of the metal mold for carrying out the heat sealing so that the air vent passage 3 is closed as in the conventional art. When the sealed portion 2 in the finished compression bag 1 is pressed by hands to discharge the air present in the sealed portion 2 to the outside of the compression bag 1, it is possible to easily carry out the deaeration almost without resistance even in the case where people having comparatively weak strength such as children and elderly people use the compression bag 1.

The valve element bonding seal S1 is previously provided separately between the front bag sheet 11 and the valve element sheet 31 and between the rear bag sheet 12 and the valve element sheet 31. In addition, the front bag sheet 11 and the rear bag sheet 12 are separated from each other in this case. Consequently, the formation of the air vent passage 3 is not adversely influenced at all by the heat generated by forming the valve element bonding seal S1 through the heat sealing and the pressure of the metal mold for carrying out the heat sealing.

Finally, the sheets 11, 12 and 31 and the closing unit 4 are cut in the vertical direction in the figure so as to divide the bag side seal S3 (16) equally. Thus, the compression bag 1 is finished (Step [6]).

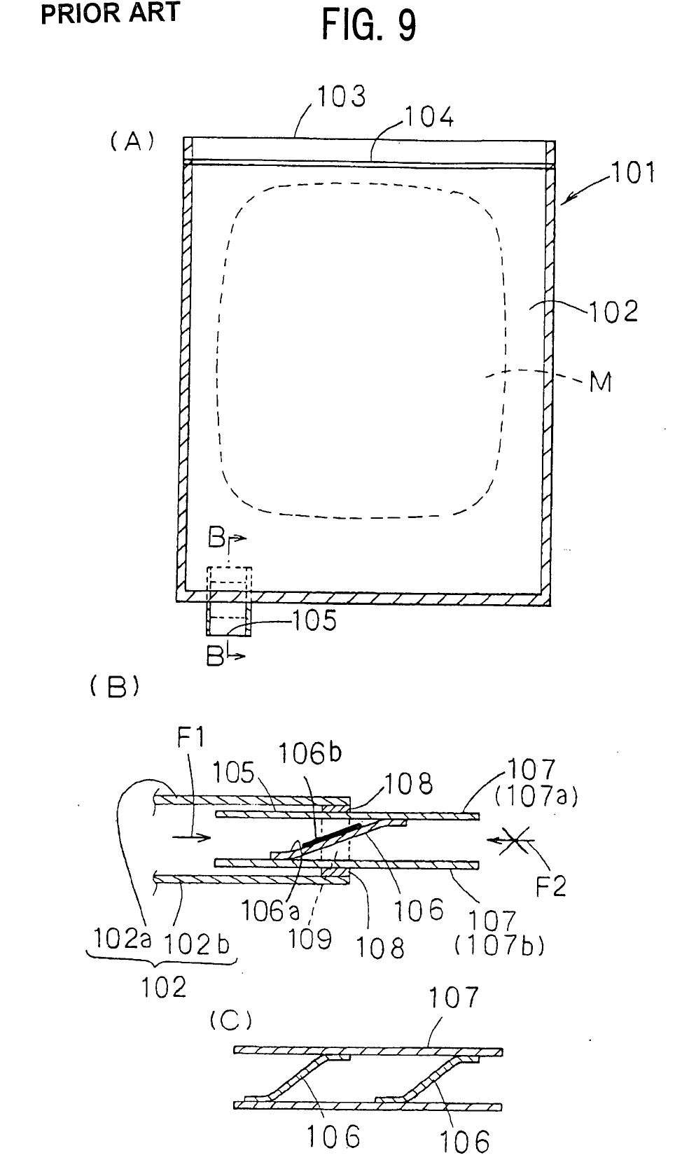

In the method of manufacturing the compression bag 1 according to the present invention, the sheets 11, 12 and 31 which are continuous in the longitudinal direction and the closing unit 4 are used and consecutively supplied in each of the steps ([1] to [6]), and the processes such as the heat sealing and the cutting are sequentially performed so that the compression bags 1 are successively formed. Therefore, it is not necessary to provide a complicated manufacturing step of manufacturing the check valve 105 separately from the sheet constituting the sealed bag 102 and incorporating the check valve 105 when forming the sealed portion 102 later as in the conventional example shown in FIG. 9. Consequently, the manufacturing can be carried out comparatively easily and the manufacturing cost can be reduced.

Next, the inventor of the present application manufactured the compression bag 1 according to the present invention on trial and carried out an experiment for measuring resistance in deaeration together with a compression bag according to a comparative example.

An example in the following Table 1 relates to a trial product of the compression bag 1 according to the present invention in which each portion, for example, the air vent passage 3 of the compression bag 1 having the configuration shown in FIG. 4 is modified (see FIG. 11A). A valve element sheet 31 used in the compression bag 1 has the same structure as that shown in FIG. 2A and is constituted by a front side valve element sheet 31x and a rear side valve element sheet 31y which are formed to have equal longitudinal dimensions (t3 in FIG. 11A), and an intermediate valve element sheet 31z formed to have a longitudinal dimension (t2) which is smaller than the those of the front side valve element sheet 31x and the rear side valve element sheet 31y.

In the compression bag 1 shown in FIG. 11A, four air vent passages 4 are provided. The compression bag 1 has a dimension of 950 mm by 700 mm. Moreover, the air vent passage 3, an extended air vent passage 3′ and the like are set to have dimensions of t1=23 mm, t2=35 mm, t3=45 mm, t4=20 mm and t5=30 mm.

An article M was accommodated in a sealed portion 2 of the compression bag 1 and the experiment was carried out by the following method in a state where a closing unit 4 was closed. As the article M, a commercially available cushion was used.

In the experiment, the compression bag 1 in the state described above was vertically interposed between two plates having rigidity, the lower plate was fixed and the upper plate was moved downward, and pressure (unit: MPa) applied to the compression bag 1 during ventilation of the air vent passage 3 was measured. A moving speed of the plate was set to 500 mm/min. In this case, a load of 100 kg was applied to the upper plate.

Regarding the compression bag according to the comparative example, the experiment was carried out in the same way.

A compression bag according to a first comparative example has a configuration shown in FIG. 11B in which the conventional check valve 105 shown in FIG. 9 is continuously provided in a transverse direction. The bag has a dimension of 980 mm by 700 mm. Each portion is set to have a dimension of t6=25 mm, t7=45 mm, t8=55 mm and t9=40 mm.

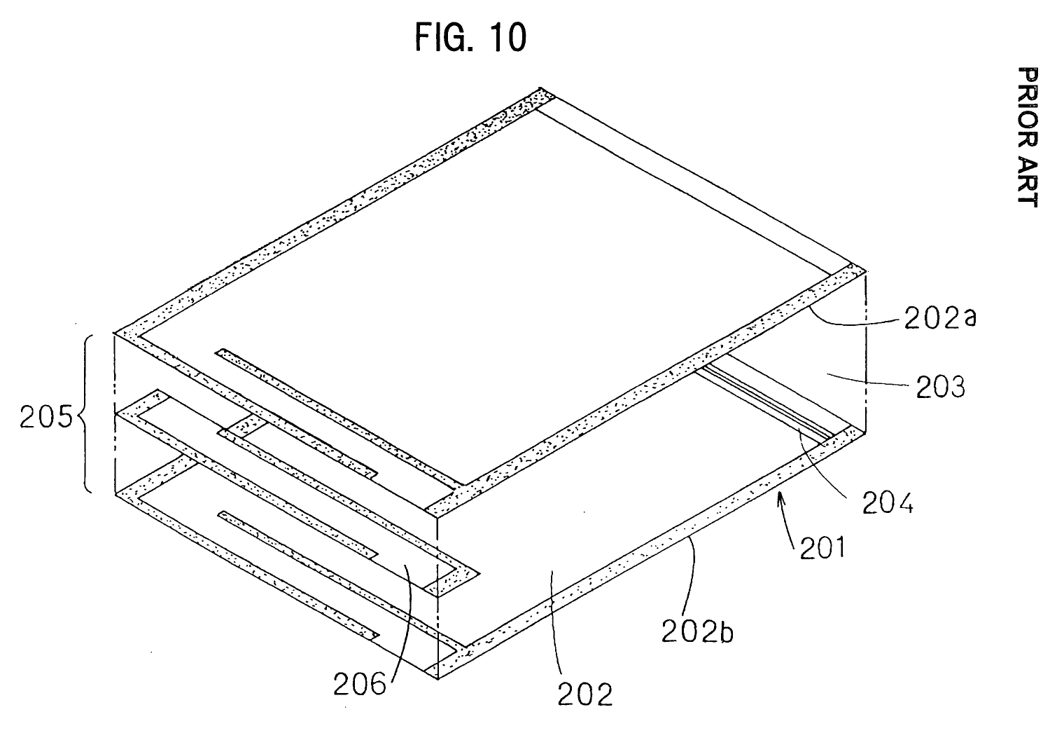

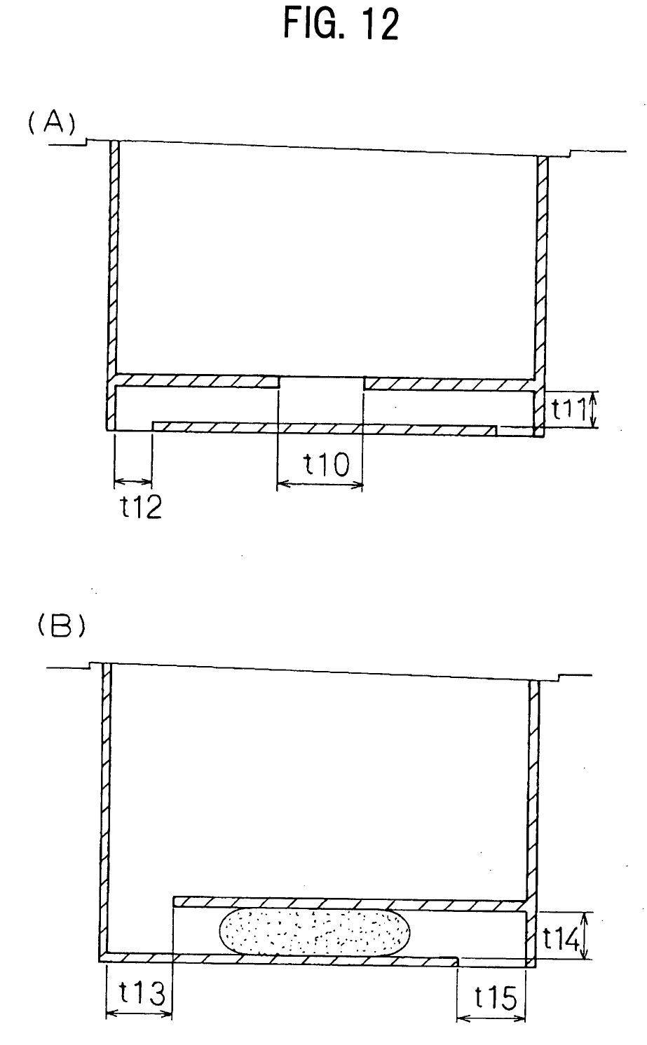

A compression bag according to a second comparative example has a configuration shown in FIG. 12A and has the same structure as that of the compression bag 201 according to the conventional example shown in FIG. 10 in which a deaeration port is provided in two places and the bag has a dimension of 900 mm by 640 mm. Moreover, each portion is set to have a dimension of t10=60 mm, t11=33 mm and t12=30 mm.

A compression bag according to a third comparative example is commercially available one, in which an air vent passage is filled with silicone oil (sticking substance) and can be closed as shown in FIG. 12B. The bag has a dimension of 650 mm by 450 mm. The air vent passage has dimensions of t13=40 mm, t14=35 mm and t15=40 mm.

A result of the measurement is shown in the Table 1. It could be actually confirmed that measured values are smaller in the example than those in the comparative examples, and the compression bag 1 according to the present invention can lightly carry out deaeration with small resistance.

TABLE 1

| | | | Pressure |
|---|---|---|---|
| | Configuration | | applied during |
| Experimental | of compression | Size of bag | ventilation |
| object | bag | (mm) | (MPa) |
| Example | FIG. 11A | 700 × 950 | 1.27 |
| First | FIG. 11B | 700 × 980 | 4.23 |
| comparative | | | |
| example | | | |
| Second | FIG. 12A | 640 × 900 | 5.15 |
| comparative | | | |
| example | | | |
| Third | FIG. 12B | 450 × 650 | 9.81 |
| comparative | | | |
| example | | | |

The present invention has the following excellent advantages.

The first to third aspects of the present invention provide a structure of an air vent passage for a sealed bag characterized in that the adhering portions C1 and C2 in which the valve element sheet 31 and the bag sheets 11 and 12 or the valve element sheet 31 on the other side which is/are opposed to the adhering surface 31a of the valve element sheet 31 are present in two places or more per a set of the valve unit 3u and a combination of the bag sheets 11 and 12 and the valve element sheet 31 or of the valve element sheets 31 which constitute the respective adhering portions C1 and C2 is different for each of the adhering portions C1 and C2. According to the structure of the air vent passage, the air current passage space 3a is doubly closed in the serial direction to the direction of the air current. Therefore, a checking effect can be obtained more reliably. In the case in which the compression bag 1 has a large size and the size of the air vent passage 3 is increased in proportion thereto, particularly, a great effect can be exhibited. Moreover, the combination of the valve element sheets 31 constituting the respective adhering portions C1 and C2 is different. Even when a defect such as leakage is caused by, e.g., the wrinkles of the valve element sheet in one of the adhering portions, therefore, it is possible to reduce the possibility that the other adhering portion is directly affected adversely by the defect. Accordingly, it is possible to provide a structure of an air vent passage for a sealed bag which can effectively prevent a backward flow of the air in the air vent passage 3 and can reliably maintain the deaeration state of the sealed portion 2 for a long period of time.

Moreover, the fourth aspect of the present invention provides a sealed bag characterized in that the adhering portions C1 and C2 in which the valve element sheet 31 and the bag sheets 11 and 12 or the valve element sheet 31 on the other side which is/are opposed to the adhering surface 31a of the valve element sheet 31 are present in two places or more per a set of the valve unit 3u and a combination of the bag sheets 11 and 12 and the valve element sheet 31 or of the valve element sheets 31 which constitute the respective adhering portions C1 and C2 is different for each of the adhering portions C1 and C2. According to the structure of the air vent passage, the air current passage space 3a is doubly closed in the serial direction to the direction of the air current. Therefore, a checking effect can be obtained more reliably. In the case where the compression bag 1 has a large size and the size of the air vent passage 3 is increased in proportion thereto, particularly, a great effect can be exhibited. Moreover, the combination of the valve element sheets 31 constituting the respective adhering portions C1 and C2 is different. Even when a defect such as leakage is caused by the wrinkles of the valve element sheet in one of the adhering portions, therefore, it is possible to reduce the possibility that the other adhering portion might be directly affected adversely by the defect. Accordingly, it is possible to provide a sealed bag which can effectively prevent a backward flow of the air in the air vent passage 3 and can reliably maintain the deaeration state of the sealed portion 2 for a long period of time.

According to the fifth aspect of the present invention, in addition to the advantage obtained by the fourth aspect of the present invention, the sealed portion partitioning seal 14 obtained by integrally bonding the bag sheets 11 and 12 to each other and extended in a transverse direction is not provided for the conducting portion of the sealed portion 2 and the air vent passage 3. Consequently, the air vent passage 3 is not closed at all by the influence of the heat sealing and resistance in deaeration can be set to be as low as possible. Therefore, in such a use as to press the sealed portion 2 by hands to discharge the air present in the sealed portion 2 to the outside of the sealed bag 1, people having comparatively weak strength such as children and elderly people can easily carry out the deaeration with very small resistance. Moreover, the sealed portion 2 can also be prevented from bursting.

Furthermore, the sixth aspect of the present invention can provide a method of manufacturing a sealed bag in which it is possible to manufacture, through one step by using the bag sheets 11 and 12 and the valve element sheet 31 which are supplied continuously in a longitudinal direction, the sealed bag 1 capable of effectively preventing a backward flow of the air in the air vent passage 3 by shifting a downstream side end of one of the valve element sheets 31 and that of at least one of the other valve element sheets 31 with respect to the direction of the air current and can reliably maintain the deaeration state of the sealed portion 2 for a long period of time, thereby reducing the manufacturing cost.

What is claimed is:

1. A structure of an air vent passage for a sealed bag, the bag (1) being capable of sealing a sealed portion (2) in an airtight state and coupled to an outside of the bag to freely carry out ventilation in order to discharge a gas present in the sealed portion (2) to the outside of the bag and maintain the state or to fill the sealed portion (2) with a gas and maintain the state, thus permitting passage of an air current in one direction and blocking an air current in the other direction by opening and closing an air current passage space (3a) that is a space through which the gas passes in order to discharge or fill the gas,
wherein the structure is comprised of flexible bag sheets (11, 12) made of a resin and a flexible valve element sheet (31) made of a resin,
the bag sheets (11, 12) being disposed opposite to each other in a longitudinal direction,
at least two valve element sheets (31) making a set and being disposed in superposition in the longitudinal direction between the bag sheets (11, 12),
wherein part of the valve element sheet (31) is bonded to either the bag sheets (11, 12) or the other valve element sheet (31) in a bonding portion (31b), and a movable portion (31c) other than the bonding portion (31b) is set to be movable, and a set of a valve unit (3u) is constituted by the set of the valve element sheets (31), and
wherein an air vent passage (3) is defined by a pair of air vent passage side seals (33) obtained by bonding the bag sheets (11, 12) and the valve element sheets (31) integrally with each other, the air vent passage (3) having one end conducted to the sealed portion (2) and the other end conducted to the outside of the bag, the air vent passage side seal (33) being formed along an air current (F1) in a forward direction in which the gas can be permitted to pass through the air vent passage, and
wherein the bonding portion (31b) of the valve element sheet (31) is disposed on an upstream side of the air current (F1) in the forward direction, and the movable portion (31c) is disposed on a downstream side of the air current in the forward direction,
wherein a surface on an opposite side to inner surfaces (11a, 12a) of the bag sheets (11, 12) on a side where the valve element sheet (31) to which the movable portion (31c) belongs is bonded in the movable portion (31c) is a separated surface (31d), and a surface provided on an opposite side of the separated surface (31d) is an adhering surface (31a), and
when the air current (F1) passes in the forward direction, the valve element sheet (31) and the bag sheets (11, 12) or the valve element sheet (31) on the other side which are opposed to the adhering surface (31a) of the valve element sheet (31) are separated from each other, then the air current passage space (3a) is opened with respect to said air current;
when an air current (F2) in a reverse direction flows in to the forward direction, the valve element sheet (31) and the bag sheets (11, 12) or the valve element sheet (31) on the other side which are opposed to the adhering surface (31a) of the valve element sheet (31) adhere to each other in adhering portions (C1, C2), then the air current passage space (3a) is closed with respect to said air current,
wherein at least two adhering portions (C1, C2) are present for each one set of the valve unit (3u),
wherein a combination constituting the respective adhering portions (C1, C2) between the bag sheets (11, 12) and the valve element sheet (31) or the valve element sheets (31) themselves is different for each of the adhering portions (C1, C2).

2. The structure of an air vent passage for a sealed bag according to claim 1, wherein a longitudinal dimension that is a dimension in a direction of an air current in one of the valve element sheets (31) to be used in the set of the valve unit (3u) is different from a longitudinal dimension of at least one of the other valve element sheets (31).

3. The structure of an air vent passage for a sealed bag according to claim 1 or 2, wherein at least a set of the valve element sheet (31) disposed relatively on a front side and the valve element sheet (31) disposed relatively on a rear side is constituted by one sheet, and
the one sheet is folded in such a manner that one side is wide and the other side is narrow by setting, as a boundary, a folding line (31d) which is disposed orthogonally to a direction of an air current.

4. A sealed bag having a sealed portion (2) and an air vent passage (3) provided adjacent to the sealed portion (2) for coupling the sealed portion (2) to the outside of the bag to freely carry out ventilation, the bag being capable of sealing the sealed portion (2) in an airtight state and of discharging a gas present in the sealed portion (2) to an outside of the bag before maintaining the state or filling the sealed portion (2) with a gas before maintaining the state, thus permitting passage of an air current in one direction and blocking the air current in the other direction by opening and closing an air current passage space (3a) that is a space through which a gas passes in the air vent passage in order to discharge or fill the gas,
wherein the sealed bag is comprised of flexible bag sheets (11, 12) made of a resin and a flexible valve element sheet (31) made of a resin,
the bag sheets (11, 12) being disposed opposite to each other,
at least two valve element sheets (31) making a set between the bag sheets, further at least part of the valve element sheets (31) being disposed in superposition in a longitudinal direction in the air vent passage (3),
wherein part of the valve element sheet (31) is bonded to the bag sheets (11, 12) or the other valve element sheet (31) in a bonding portion (31b), and a movable portion (31c) other than the bonding portion (31b) is set to be movable, and a set of a valve unit set (3u) is constituted by the set of the valve element sheets (31), and
wherein the air vent passage (3) is defined by a pair of air vent passage side seals (33) obtained by bonding the bag sheets (11, 12) and the valve element sheets (31) integrally with each other and formed along an air current (F1) in a forward direction in which a gas is permitted to pass through the air vent passage (3), the air vent passage having one end conducted to the sealed portion (2) and the other end conducted to the outside of the bag,
wherein the bonding portion (31b) of the valve element sheet (31) is disposed on an upstream side in the air current (F1) in the forward direction, and the movable portion (31c) is disposed on a downstream side in the air current in the forward direction in the air vent passage,
wherein a surface on an opposite side to the bag sheets (11, 12) on a side where the valve element sheet (31) to which the movable portion (31c) belongs is bonded or the other valve element sheet (31) on a side where the valve element sheet (31) to which the movable portion (31c) belongs is bonded is a separated surface (31d) in the movable portion (31c), and a surface provided on an opposite side of the separated surface (31d) is an adhering surface (31a), and
when the air current (F1) passes in the forward direction, the valve element sheet (31) and the bag sheets (11, 12) or the valve element sheet (31) on the other side which are opposed to the adhering surface (31a) of the valve element sheet (31) are separated from each other, then the air current passage space is opened with respect to said air current (3a);
when an air current (F2) in a reverse direction flows in to the forward direction, the valve element sheet (31) and the bag sheets (11, 12) or the valve element sheet (31) on the other side which are opposed to the adhering surface (31a) of the valve element sheet (31) adhere to each other in adhering portions (C1, C2), then the air current passage space (3a) is closed with respect to said air current, and
wherein at least two adhering portions (C1, C2) are present for each one set of the valve unit (3u), and
wherein a combination constituting the respective adhering portions (C1, C2) between the bag sheets (11, 12) and the valve element sheet (31) or the valve element sheets (31) themselves is different for each of the adhering portions (C1, C2).

5. The sealed bag according to claim 4, wherein the sealed portion (2) is a portion on an upper side of a sealed portion partitioning seal (14), the portion being defined by the sealed portion partitioning seal (14) and a bag side seal (16) for defining both of left and right ends of the sealed bag (1), the sealed portion partitioning seal (14) being obtained by integrally bonding at least the bag sheets (11, 12) and extended in a transverse direction,
the air vent passage (3) is further defined by the air vent passage side seal (33) in a lower portion defined by the sealed portion partitioning seal (14), and
the sealed portion partitioning seal (14) is not provided for a conducting portion of the sealed portion (2) and the air vent passage (3).

6. A method of manufacturing a sealed bag having a sealed portion (2) and an air vent passage (3) provided adjacent to the sealed portion for coupling the sealed portion (2) to the outside of the bag to freely carry out ventilation, the bag being capable of sealing the sealed portion (2) in an airtight state and of discharging a gas present in the sealed portion (2) to an outside of the bag before maintaining the state or filling the sealed portion (2) with a gas before maintaining the state, thus permitting passage of an air current in one direction and blocking the air current in the other direction by opening and closing an air current passage space (3a) that is a space through which a gas passes in the air vent passage in order to discharge or fill the gas,
wherein the method is comprised of the steps of:
using flexible bag sheets (11, 12) made of a resin and flexible at least two valve element sheets (31) made of a resin, the bag sheets being supplied continuously in a longitudinal direction, the valve element sheets being supplied continuously in the longitudinal direction and having a longitudinal dimension that is a dimension in a short direction and is smaller than longitudinal dimensions of the bag sheets (11, 12);
superposing the valve element sheet (31) on the front bag sheet (11) and the rear bag sheet (12) in a portion where an air vent passage (3) is to be formed;
bonding the bag sheets (11, 12) and the valve element sheet (31) together by forming a valve element adhesive seal (S1, 31b) in a part of an upstream side in an air current (F1) in a forward direction in which a gas is permitted to pass through the air vent passage (3) in the valve element sheet (31);
superposing the front bag sheet (11) and the rear bag sheet (12) in such a manner that the valve element sheet (31) is disposed inside;
shifting a downstream side end in one of the valve element sheets (31) and a downstream side end in at least one of the other valve element sheets (31) in the superposed state from each other with respect to a direction of an air current; and
forming a bag side seal (S3, 16) and a sealed portion partitioning seal (S2b, S41b, 14) in order to define the sealed portion (2), the seals being provided to bond the bag sheets (11, 12) integrally with each other in portions other than an opening portion (1a) for putting in and out of an article and a portion coupling the sealed portion (2) and the air vent passage (3), and
forming an air vent passage side seal (S42, 33) in order to define the air vent passage (3), the seal being obtained by bonding the bag sheets (11, 12) and the valve element sheet (31) integrally with each other and extended in a direction along the air current (F1) in the forward direction.
